(19) United States
(12) Patent Application Publication
(10) Pub. No.: US 2026/0210148 A1
(43) Pub. Date: Jul. 23, 2026

(54) Casualty Evacuation Ecosystem

(71) Applicant: The Government of the United States, as Represented by the Secretary of the Army, Fort Detrick, MD (US)

(72) Inventor: Titus J. Rund, Eagle River, AK (US)

(21) Appl. No.: 19/137,331

(22) PCT Filed: Dec. 13, 2023
(86) PCT No.: PCT/US2023/083774

§ 371 Date: Jun. 10, 2025

Related U.S. Application Data
(60) Provisional application No. 63/432,454, filed on Dec. 14, 2022.
(60) Provisional application No. 63/481,571, filed on Jan. 25, 2023.

(51) Int. Cl. E04H 15/20; A61G 1/013; A61G 10/00

(52) U.S. Cl. CPC E04H 15/20; A61G 1/013; A61G 10/005; A61G 2220/00; E04H 2015/201

(57) ABSTRACT

The present invention is directed to a casualty evacuation ecosystem. The ecosystem includes a Casualty Protection Unit (CPU) and a Casualty Collection Point Shelter (CCP), both of which provide shelter, heat, and care for a casualty. The CPU may include an inflatable structure and a waterproof material; at least one inflation port; and at least one heat source. The CCP may include at least one inflatable tent or tent-like structure having at least one portal capable of receiving a casualty protection unit.

This PCT international application claims priority to U.S. Ser. No. 63/481,571 filed on 25 Jan. 2023 and U.S. Ser. No. 63/432,454 filed on 14 Dec. 2022 in the U.S. Patent and Trademark Office, the entireties of which are incorporated herein by reference.

### FIELD OF THE INVENTION

The present invention is directed to a casualty evacuation ecosystem. In particular, the casualty evacuation ecosystem includes a Casualty Protection Unit (CPU) and a Casualty Collection Point Shelter (CCP), both of which provide shelter, heat, and care for a casualty. The ecosystem helps manage pre-hospital care of casualties and may decrease their risk of developing traumatic or accidental hypothermia. The ecosystem may also stabilize and/or reverse existing traumatic or accidental hypothermia in casualties.

### BACKGROUND OF INVENTION

Tactical Combat Casualty Care (TCCC) has advanced significantly over the last 20 years of counter insurgency operations and has led to the highest level of survivability in the history of combat medicine. During the transition to new paradigms for future conflict, numerous articles are being written questioning the feasibility of delivering casualties for damage control surgery within the Golden Hour (i.e., the period of time following an injury during which there is the highest likelihood that prompt medical and surgical treatment will prevent death).

These questions may be prompted due to expeditionary, contingency, small-scale combat operations; large-scale combat operations; or simply due to the large expanse of geography and the lack of forward-positioned resources. In operational terms, this is the “tyranny of distance and time”, which is an important planning factor that influences operational risk assessments and decisions on resource allocation to mitigate risk.

In cold weather environments, for example Alaska, the tyranny of distance and time is particularly significant as such regions may be sparsely populated, road infrastructure may be limited, and medical infrastructure outside of cities lacks surgical coverage that medical planners could use in contingency operations. One potentially serious issue is the care of traumatically injured casualties in which traumatic hypothermia is difficult to manage.

Research now demonstrates that the core body temperature in traumatic hypothermia is at a higher threshold than described in the accidental hypothermia populations. The Wilderness Medical Societies' 2019 Clinical Practice Guideline for accidental hypothermia defines a core body temperature of 35-37° C. as “cold stress” and a core body temperature of 32-35° C. as “mild hypothermia.” In contrast, a 2022 retrospective review of the US Department of Defense's Trauma Registry looked at traumatic hypothermia and found that a core body temperature of 36.2° C. is a threshold value for worsening mortality in the combat trauma population and “current methods for pre-hospital warming are insufficient”.

Without appreciating the significance of this higher threshold value in the “traumatic” versus “accidental” populations, interventions may be delayed, thereby affecting mortality. Conversely, if solutions or treatments to arrest and/or possibly reverse hypothermia can be employed sooner, a TCCC practitioner can optimize a casualty for delayed damage control resuscitation.

There is a need for a paradigm shift in TCCC and in the medical logistics needed to support medical operation in arctic and extreme cold environments and to transport and/or treat casualties suffering from accidental or traumatic hypothermia.

### SUMMARY OF INVENTION

The invention provides in a first embodiment a casualty protection unit comprising an inflatable structure and a waterproof material; at least one inflation port; and at least one heat source. The inflatable structure may comprise at least one of an inflatable liner, air beam, air bladder, or raft.

The invention provides in a second embodiment further to any of the previous embodiments a casualty protection unit in which the inflatable structure comprises a plurality of inflatable and isolated chambers, each chamber having its own inflation port.

The invention provides in a third embodiment further to any of the previous embodiments a casualty protection unit in which the at least one heat source is a charcoal heater, chemical cartridge or packet, or an electrical resistance heating element.

The invention provides in a fourth embodiment further to any of the previous embodiments a casualty protection unit further comprising a thermoreflective sheet or bag removably attachable to or bonded to an interior lining of the unit. The thermoreflective sheet or bag may comprise integrated or interwoven thermoresistive heating elements including nanofibers or nanowires.

The invention provides in a fifth embodiment further to any of the previous embodiments a casualty protection unit further comprising a removable or an attached top having an angled section with a clear window.

The invention provides in a sixth embodiment further to any of the previous embodiments a casualty protection unit further comprising built-in speakers and/or other means for communicating with a casualty.

The invention provides in a seventh embodiment further to any of the previous embodiments a casualty protection unit further comprising at least one removable, inflatable air beam or air bladder configured to allow the unit to slide along it.

The invention provides in an eighth embodiment a casualty collection point shelter comprising at least one inflatable tent or tent-like structure having at least one portal capable of receiving the casualty protection unit of any one of the previous embodiments.

The invention provides in a ninth embodiment further to any of the previous embodiments a casualty collection point shelter comprising a plurality of portals, each side of the structure having a portal.

The invention provides in a tenth embodiment further to any of the previous embodiments a casualty collection point shelter in which the inflatable structure comprises at least one of an electromagnetic radiation reducing liner or a thermoreflective liner.

The invention provides in an eleventh embodiment further to any of the previous embodiments a casualty collection point shelter further comprising at least one heat source. There may also be a fan and vent system that distributes heat from at least one heat source.

The invention provides in a twelfth embodiment a tactical evacuation system comprising a casualty protection unit according to any one of the previous embodiments connectable to a vehicle that provides electrical power to the casualty protection unit. The vehicle may be a snowmobile or snowmachine.

The invention provides in a thirteenth embodiment further to any one of the previous embodiments a tactical evacuation system according to any of the previous embodiments in which the casualty protection unit includes at least one of batteries or a battery bank, a radio, or communication equipment.

The invention provides in a fourteenth embodiment further to any one of the previous embodiments a tactical evacuation system in which the casualty protection unit is connectable to a communication system of a vehicle.

### BRIEF DESCRIPTION OF THE DRAWINGS

FIGS. 1A-1B schematically show perspective views of a casualty protection unit (CPU) according to one embodiment of the present invention. FIG. 1C shows the deployment of a CPU in combat and the loading of a casualty into a CPU.

FIG. 2A schematically shows a view of a casualty collection point shelter (CCP) for at least partially housing at least one CPU according to one embodiment of the present invention. FIG. 2B shows a schematic interior view of a CCP. FIG. 2C shows a top view of two CCPs linked together.

FIG. 3A schematically shows a tactical evacuation system with a CPU attached to a vehicle according to one embodiment of the present invention. FIG. 3B shows a perspective view of a CPU transporting equipment.

### DETAILED DESCRIPTION OF INVENTION

The present invention is directed to a casualty evacuation (e.g., CASEVAC) ecosystem. In particular, the casualty evaluation ecosystem includes a Casualty Protection Unit (CPU) and a Casualty Collection Point Shelter (CCP), both of which provide shelter, heat, and care for a casualty. Thus, the ecosystem helps managing pre-hospital casualties with an emphasis on management of traumatic and/or accidental hypothermia. The CPU and CCP may be used, in particular, in cold weather environments, such as the arctic, Alaska, or other extreme cold environments.

However, due to their multifunctionality, they can be used in coastal, littoral, or tropical environments as well as in rough terrain and mountainous evacuations.

In this detailed description, references to “one embodiment”, “an embodiment”, or “in embodiments” mean that the feature being referred to is included in at least one embodiment of the invention. Moreover, separate references to “one embodiment”, “an embodiment”, or “embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

As used herein “substantially”, “generally”, “about”, and other words of degree are relative modifiers intended to indicate permissible variation from the characteristic so modified (e.g., ±0.1%, ±0.5%, ±1.0%, ±2%, ±5%, ±10%, ±20%). It is not intended to be limited to the absolute value or characteristic which it modifies but rather possessing more of the physical or functional characteristic than its opposite, and preferably, approaching or approximating such a physical or functional characteristic.

### I. Care Under Fire Phase—Casualty Protection Unit

In a Care Under Fire (CUF) phase of combat, continued enemy action and/or environmental exposure are threats faced by a TCCC practitioner. As such, focused and expedient action to remove a casualty and protect the TCCC practitioner is necessary. About 68% of casualty deaths occur in the CUF phase within about 10 minutes from the point of injury.

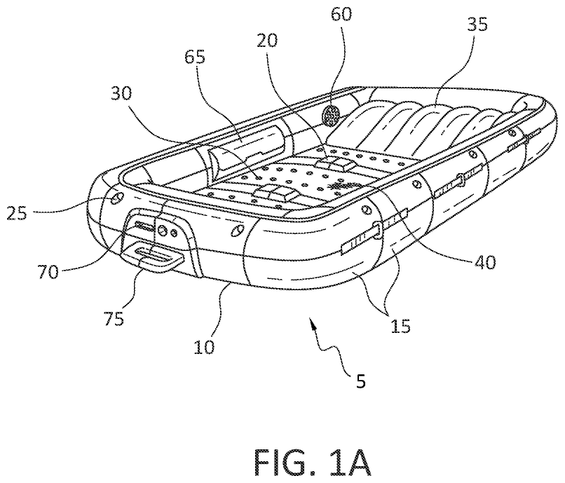

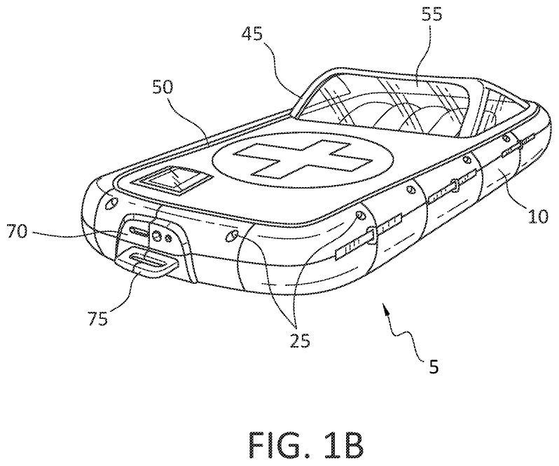

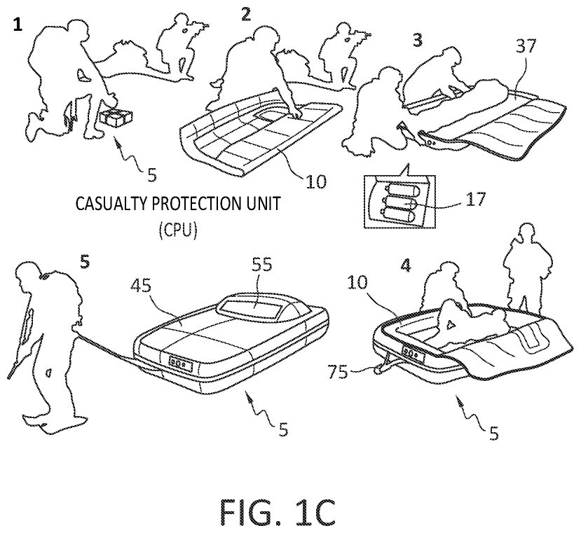

As shown in FIGS. 1A-1C, a first component of the casualty evaluation ecosystem of the present invention is a Casualty Protection Unit (CPU) 5, which is designed to manage or arrest hypothermia by protecting a casualty from the environment. In embodiments, the CPU may weigh about 5 pounds to about 15 pounds (2.3 kg to 6.8 kg), for example, about 8 pounds to about 10 pounds (3.6 kg to 4.5 kg). The CPU may be vacuum-packed for easy transport over difficult terrain, for example, in a backpack or delivery via a drone.

The CPU has the functionality of a sled, pulk, or litter. The CPU 5 may comprise an inflatable structure 10 comprising at least one of an inflatable liner, air beam, air bladder, or raft-like structure that comprises a waterproof material. The CPU prevents or substantially inhibits intrusion of cold air, snow, or water from further cooling a casualty and protects the casualty from exposure. The inflatable structure may have a single or a plurality of inflatable and isolated chambers 15, which helps prevent a complete collapse of the CPU in the event of a rupture.

As shown in FIG. 1C, according to one non-limiting embodiment of the present invention, a casualty does not need to be lifted. Step 1 shows a vacuum-packed CPU 5. Step 2 shows the unpacking of a CPU 5. The CPU may be pulled underneath a casualty or the casualty can be rolled onto the inflatable structure (Step 3) prior to it being inflated (Step 4). This feature optimizes a TCCC practitioner's human performance and energy expenditure. The inflatable structure 10 can provide a protection from trauma (e.g., bouncing impact) while the CPU is towed (Step 5). In embodiments, the CPU 5 may have at least one strap 20 (e.g., magnetic strap, strap with buckle, or hook-and-loop strap) to secure and immobilize a casualty.

The inflatable structure 10 may be selectively inflated, and also selectively deflated, via at least one inflation port 25. There may be a plurality of inflation ports, each inflation port corresponding to a separate inflatable chamber 15. In embodiments, the CPU may have at least one of an inflation cartridge or module 17; a manual pump; or a fill bag/bladder for inflating the inflatable liner/structure. These devices may be stored along with CPU packaging or externally from such packaging. In an embodiment, an inflation cartridge or module may contain any effective gas, such as air, nitrogen, or CO₂. In a particular embodiment, the inflation cartridge or module contains nitrogen, which is stable in cold environments.

In embodiments, the CPU 5 may comprise a material including, but not limited to, polyurethane, polyvinylchloride (PVC), high density polypropylene (HDPE), an ultra-high molecular weight (UHMW) polymer, or any suitable material that is serviceable in a desired temperature range, for example, −40° F. to −65° F. (−42° C. to −53.8° F.) in cold weather environments. The inflatable structure and any dead air space elements or pockets may comprise any appropriate material that has an “R-value” of insulation of at least 6, which will thermally protect a casualty. In a specific embodiment, a bottom of the CPU may comprise one-sided PVC for at least one of durability, puncture resistance, or decreased coefficient of friction. Alternate embodiments may have HDPE or UHMW polymer film or tape that confer at least one of durability, puncture resistance, or decreased coefficient of friction. This configuration allows for better movement over snow, over uneven terrain, or through water.

In embodiments, the CPU 5 may have a system for draining at least one of blood, melted snow, or other liquid away from the insulated casualty. In embodiments, the system may include at least one of a channel or a plurality of drainage holes 30 into a sealed or self-bailing floor of the CPU. In an embodiment, there may be an absorbent material in the sump area.

In embodiments, the CPU 5 may have a separable and removable head of bed (HOB) elevation 35 for casualty airway protection. The head of bed 35 may comprise an inflatable wedge to raise the head of a casualty, for example about 30° to 50° with respect to a bottom of the CPU. The head of bed may also be removable and may be used as a personal flotation device or inflatable splint.

In embodiments, the CPU may contain a thermoreflective sheet or bag 37 that can be used to wrap the casualty. The sheet or bag may be removably attachable to or bonded to an interior lining of the CPU or may be a separate liner within a packaging for the CPU. The sheet or bag may comprise MYLAR®. The sheet or bag may also have a vapor barrier material, such as a plastic or foil.

In embodiments, the thermoreflective sheet or bag or a separate liner may have thermoresistive heating elements integrated or interwoven therein, bonded, or 3D-printed thereon. The electrical heating elements may include, but are not limited to, nanofibers or nanowires 40, for example made from graphene or ceramic. The thermoresistive elements are connectable to a power source to provide heating for a casualty. The power source may be at least one of a generator, power from a vehicle, or a battery. In one specific embodiment, the power source may not be a battery, as batteries may not be optimal for cold or arctic environments.

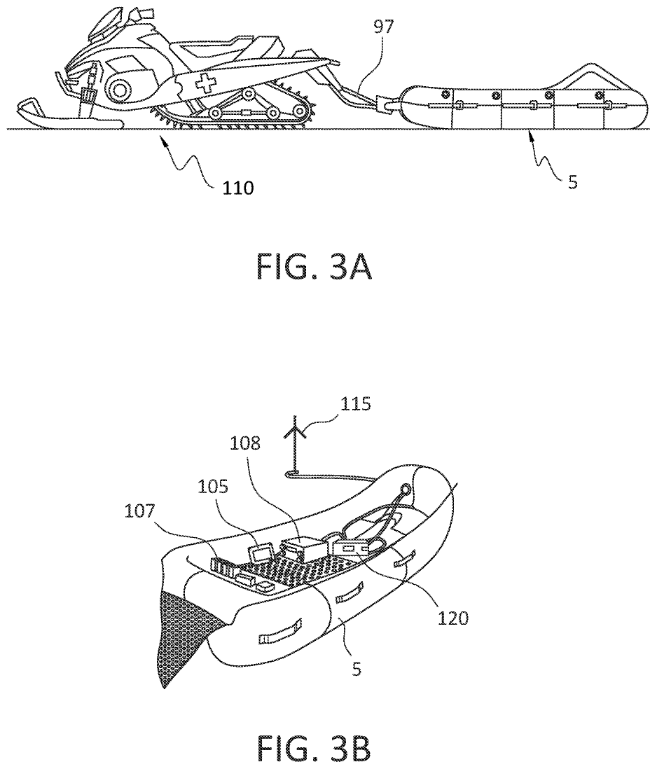

In embodiments, the CPU may have at least one heat source (see e.g., 120 in FIG. 3B). In an embodiment, the heat source may comprise a charcoal heater or cartridge, for example a Heatpac system or component thereof as previously available from Normeca AS, or a chemical cartridge or packet. In one embodiment, the heat source may be housed within or external to an interior pouch or compartment of the CPU. Alternatively, or in addition thereto, the at least one heat source may comprise at least one electrical resistive heating element.

In one embodiment, the at least one heat source may be connectable to an available power source such as at least one of a generator, a vehicle, or a battery. The power from a vehicle may be “parasitic power”, thereby tapping power from the vehicle that is not otherwise consumed. In embodiments, the power may provide an electric power source for a least one of heating a casualty inside the CPU; heating interior pouch 65 and/or temperature-sensitive items (e.g., blood storage devices, IV fluids or blood warmers); or heating the thermoreflective sheet or bag 37 or thermoresistive heating elements. In one embodiment, the power source may not be a battery, as batteries may not be optimal for cold or arctic environments.

In embodiments, the CPU may have a fan and vent system incorporated with and/or hooked up to the at least one heat source for distributing heat evenly through the CPU.

The fan/vent system may be inside the CPU and may help control levels of at least one of carbon monoxide, carbon dioxide, and moisture.

In embodiments, the CPU may have an attached or a removable top 45, which can be attached via a fastener 50, including but not limited to, a heavy duty zipper, snaps, hook-and-loop fastener, or buckle. In a specific embodiment, the attached or removable top 45 may have an angled section that provides a clear window 55 for visibility, which supports enhanced situational awareness and monitoring of a casualty, equipment or supplies inside the CPU.

The CPU may have built-in speakers 60 and/or Bluetooth communication headset for communicating with a casualty and an interior pouch 65 for housing medical documentation and supplies (e.g., blood, IV fluids, pump).

In embodiments, the CPU may have at least one cable port 70 for obtaining power, for example, from an attached vehicle, such as a snowmobile, off-road vehicle, or ATV.

The CPU may be moved in multiple ways. The CPU may be towed by an individual, for example, using a rope or cord attached to an anchor point or tow hook 75 on the CPU (FIG. 1C). The CPU may also be placed on an ultrahigh molecular weight (UHMW) polyethylene, a high density polypropylene (HDPE) or other sled, which may be available from a medic or military personnel, when the CPU must be transported for longer distances. The CPU may also be placed on a haul sled or other protective transport platform when the CPU must be transported by a vehicle (e.g., snowmachine, off road vehicle, OTV, ATV) for additional protection of the casualty when speed or rough terrain may place the casualty in the CPU at risk of injury.

In one embodiment, the CPU may include at least one removable, inflatable air beam or air bladder. The inflatable air beam allows the CPU to move or slide along it, for example, along a beam from the top of a tussock/muskeg knob to another tussock/muskeg knob. In embodiments, a plurality of air beams may be connectable together to form a continuous rail. This feature reduces load carriage of one or more CPUs over rough terrain, minimizes injury to the casualty movement team member(s) and enhances human performance by offsetting load carriage and muscular fatigue.

The inflatable and removable air beam may, in embodiments, have foldable paddles on one or both ends that can be used for splinting fractures or for placing under the knees of a casualty to reduce pressure on the spine, when not in use as a paddle in littoral operations. In one embodiment, the paddles may be erected to create a mast that can be used for an antenna array.

More than one CPU may be linked together, thereby minimizing a number of trips and/or a number of TCCC practitioners needed to transport more than one casualty. In embodiments, each CPU may be placed on its own sled. Multiple CPUs may be bundled together to create a mobile floating platform (e.g., a pontoon raft) to support movement of large and/or heavy objects (e.g., a snowmachine and/or haul sled) in littoral or water-based operations.

### II. Tactical Field Care Phase—Casualty Collection Point Shelter

In a Tactical Field Care (TFC) phase of combat, application of a MARCH (Massive Hemorrhage, Airway, Respirations, Circulation, Head Injury) or MhARCH (including prioritizing hypothermia after massive hemorrhage) assessment and/or intervention may be performed on a casualty.

For this assessment and intervention to occur quickly (e.g., in about 10-60 minutes from injury), casualty movement to an area that is tactically secured and/or environmentally protected must occur quickly. The quick securing and protecting has a beneficial effect on hypothermia management along with additional management or improvement on other metabolic derangements (e.g., acidosis and hypercoagulability).

According to the present invention, a second component of the casualty evacuation ecosystem is a Casualty Collection Point Shelter (CCP). The CCP provides rapid sheltering for one or more casualties as well as at least one TCCC practitioner. The CCP provides a functional space while minimizing weight and cubic volume, which allows for an increase in the speed of bringing the CCP to a desired temperature and for preservation of heat. In specific embodiments, the CCP may weigh less than about 15 lbs (7 kg).

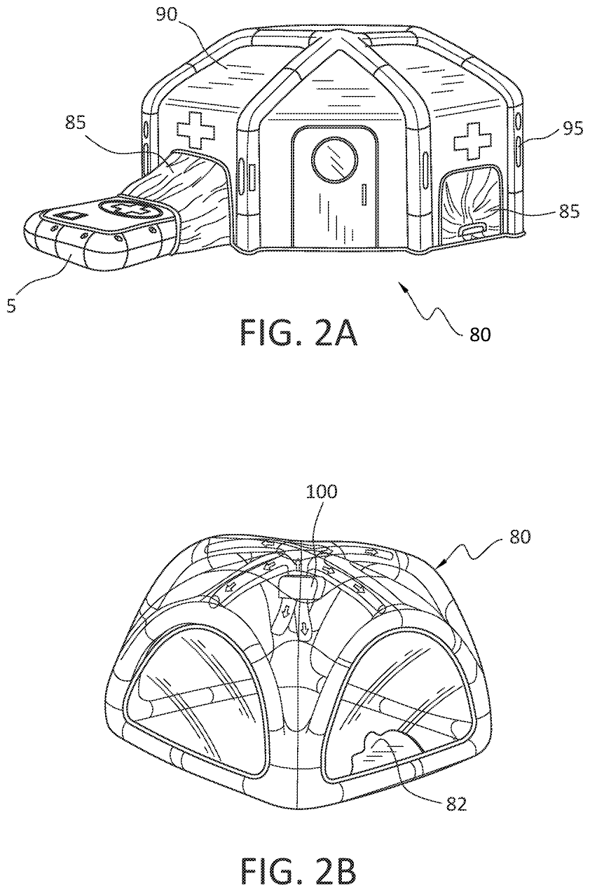

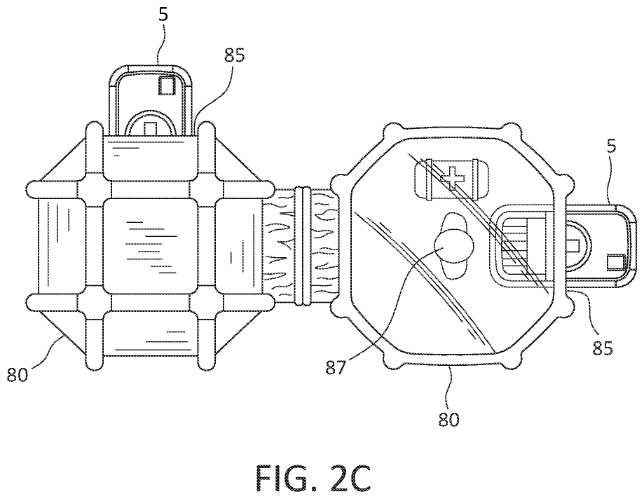

As shown in FIGS. 2A-2C, the CCP 80 may be an inflatable tent or tent-like structure having at least one portal 85 or alternate access point, for example a plurality of portals, which allow for the passage of a CPU 5 at least partially, and in some embodiments fully, into the CCP 80. In a specific embodiment, there is one portal on each side of the CCP. The at least one portal may be openable and closeable for example via snaps, a zipper, or a hook-and-loop fasteners, which may allow for progressive exposure of patient.

In specific embodiments, the CCP 80 may comprise at least one of an electromagnetic (EM) radiation reducing material/liner or a thermoreflective material/liner 90, such as a thermoreflective fabric, on an interior and/or exterior surface of the CCP. In embodiments, the at least one of an electromagnetic or a thermoreflective material may be integrated into an interior liner of the CCP or may be integrated into an outer liner or fabric of the CCP. The at least one of an electromagnetic or a thermoreflective material 90 may help minimize an electromagnetic and/or heat signature and thus provide a degree of camouflage. The CCP may also have at least one packet 95 for storing at least one signaling device (e.g., placard, signage, chemical light, glowstick, or LED light) on an exterior surface to indicate the approximate location of the at least one portal opening.

In embodiments, as shown in FIG. 2B the CCP may have at least one heat source 100, for example, a heat pack comprising a charcoal heater or an alternate heat source (e.g., hanging stove). In a specific embodiment, the CCP may also have a fan (e.g., an electrical or thermomechanical fan) that redistributes any heat from the at least one heat source. The fan may be in an upper one-third of the interior CCP. The at least one heat source may be the same heat source as carried in or provided with a CPU as discussed above.

The CCP 80 has several benefits. The at least one portal 85 minimizes the time to conduct casualty assessments within the CCP by allowing one or more CPUs to pass directly (e.g., slide) into the CCP without exposing a casualty to the environment. This capability removes the need to unpack a casualty from a sled/pulk/litter, lift, and transfer the casualty into a tent. By not having to lift and transfer a casualty, human performance is optimized as well as eliminating risks for slips, trips, and falls as well as musculoskeletal injury to TCCC practitioners in current casualty movement practice.

The CCP 80 can be erected almost anywhere, either with a floor 82 or without a floor (e.g., using the ground or snow). Thus, in embodiments, there is no need to dig down to a solid surface or packed snow. Alternatively, it is possible to dig down into the ground or snow to provide a cold sump, while providing a floor (e.g., waterproof floor) at the same level as the ground. A floor may be removable or omitted in different variants, thereby minimizing weight without compromising casualty care, as a CCP both distributes weight and serves as an insulating treatment platform, while concurrently providing and/or preserving heat. In a specific embodiment, a removable floor may also be used as a single wall snow shelter.

The combination of more than one portal 85 with a plurality of CPUs 5 allows for continuous monitoring and re-triage of multiple casualties within a CCP 80, while also supporting assessment and/or treatment of one or more casualties. This allows for situational awareness of casualties'status if managed in separate CCPs.

Finally, as shown in FIG. 2C, the CCP 80 may be a module, thereby allowing multiple CCPs to be linkable or connectable together for casualty overflow and near continuous re-triage based on casualty organization, collection, and classification of severity, which optimizes casualty prioritization for evacuation. This modularity helps TCCC practitioners 87 treat and manage both minimally-injured casualties and more severe casualties, while providing supervision and instruction and supporting two-way communication inside one or more CCPs. This configuration promotes visual and/or auditory communication, while limiting electromagnetic spectrum communications that may be targeted by an enemy.

The CCP and/or CPU may have a chemical packet which, when activated, creates an expanding foam that can at least partially fill dead air space or air beams or bladders. Once cured, the foam may provide an R-value, while also providing structural support to a CCP and/or CPU in the event that the structure fails due to lost air pressure or tears in dead air space pockets. This filling and curing may prevent deflation and reinflation of a CPU or CCP, but will ensure longer use of the structures. In embodiments, the chemical packet is connectable to at least one inflation port or may be deployed via an injection needle that is punctured into at least one space needing foam.

### III. Tactical Evacuation Phase

As shown in FIGS. 3A-3B, in a Tactical Evacuation Phase of combat, a CPU 5 may be adjusted for transport of a casualty, for example, by an electrical cable connection 97 to a vehicle 110, such as a snowmobile or snowmachine, off-road vehicle (ORV), or all terrain vehicle (ATV).

In specific embodiments, however, a CPU 5 may be used without a casualty to transport equipment including, but not limited to, batteries or a battery bank 107, radios, communication equipment 108, or temperature sensitive items, and the like. When equipment is transported, the temperature in the CPU does not need to be as high as the temperature when the CPU is used for hypothermia management of a casualty. Thus, the temperature can be set to a specific requirement (e.g., operating temperature for a radio, other communication equipment, or temperature sensitive equipment).

The CPU may have a device (e.g., Squad Power Manager™ (SPM)) 105 for energy harvesting and distribution of dirty sine wave output power to clean sine wave input power among electrical devices. The device may use energy from at least one of a generator or from vehicle 110. In addition, using power or parasitic power from the vehicle, a CPU 5 may tie into or be connectable (e.g., via hardwire, Bluetooth or other wireless system) with a communication system of the vehicle. This feature enables operational support for real time communication in support of continuously monitoring a casualty. The CPU may also have an antenna 115 and a heat source 120, which may may heat temperature-sensitive cables or materials susceptible to breakage outside of a temperature-controlled CPU.

### INDUSTRIAL APPLICABILITY

The present invention is directed to a casualty evacuation ecosystem. In particular, the casualty evaluation ecosystem includes a Casualty Protection Unit and a Casualty Collection Point Shelter useful in cold weather environments.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

1. A casualty protection unit, comprising:
an inflatable structure and a waterproof material;
at least one inflation port;
at least one heat source; and
at least one of a channel or a plurality of drainage holes configured to drain at least one of blood, melted snow, or other liquid away from a casualty into a sealed or self-bailing floor.

2. The casualty protection unit according to claim 1, wherein the inflatable structure comprises an inflatable liner, air beam, air bladder, or raft.

3. The casualty protection unit according to claim 1, wherein the inflatable structure comprises a plurality of inflatable and isolated chambers, each chamber having its own inflation port.

4. (canceled)

5. The casualty protection unit according to claim 1, wherein the at least one heat source is a charcoal heater, chemical cartridge or packet, or an electrical resistance heating element.

6. The casualty protection unit according to claim 1, comprising a material including at least one of polyurethane, polyvinylchloride, high density polypropylene (HDPE), or an ultra-high molecular weight (UHMW) polymer material.

7. The casualty protection unit according to claim 1, comprising a material having an insulative R-value of at least 6.

8. The casualty protection unit according to claim 1, further comprising a thermoreflective sheet or bag removably attachable to or bonded to an interior lining of the unit configured to wrap the casualty or as a separate liner.

9. The casualty protection unit according to claim 8, wherein the thermoreflective sheet or bag comprises integrated or interwoven thermoresistive heating elements including nanofibers or nanowires.

10. The casualty protection unit according to claim 1, wherein the at least one heat source is connectable to at least one of a generator or a vehicle.

11. The casualty protection unit according to claim 1, further comprising a removable top attachable via a fastener and having an angled section with a clear window.

12. (canceled)

13. The casualty protection unit according to claim 1, further comprising at least one removable, inflatable air beam or air bladder configured to allow the unit to slide along it.

14. A casualty collection point shelter comprising:
at least one inflatable tent or tent-like structure having a plurality of portals, each portal configured to slidably receive the casualty protection unit of claim 1.

15-16. (canceled)

17. The casualty collection point shelter of claim 14, wherein the inflatable structure comprises at least one of an electromagnetic radiation reducing liner or a thermoreflective liner configured to minimize an electromagnetic and/or heat signature and provide a degree of camouflage.

18. The casualty collection point shelter of claim 14, further comprising:
at least one heat source; and
a fan and vent system that distributes heat from the at least one heat source.

19-20. (canceled)

21. The casualty collection point shelter of claim 14, further comprising a packet that provides an expandable foam to at least partially fill dead air space of the inflatable structure.

22. (canceled)

23. A tactical evacuation system, comprising a casualty protection unit according to claim 1 connectable to a vehicle that provides electrical power to the casualty protection unit.

24. The tactical evacuation system according to claim 23, wherein the vehicle is a snowmobile or snowmachine.

25. (canceled)

26. The tactical evacuation system according to claim 23, further comprising a device for energy harvesting and distribution of power from at least one of a generator or the vehicle to electrical devices in the casualty protection unit.

27. (canceled)

28. The casualty protection unit according to claim 1, wherein the inflatable structure comprises an air beam.

29. The casualty protection unit according to claim 1, further comprising a separable and removable head of bed elevation comprising an inflatable wedge configured to raise the head of a casualty about 30° to 50° with respect to a bottom of the CPU.

30. The casualty collection point shelter of claim 14, wherein the shelter weighs less than about 15 lbs (7 kg) and wherein the shelter has no floor.
